(19) United States
(12) Patent Application Publication
(10) Pub. No.: US 2025/0142334 A1
(43) Pub. Date: May 1, 2025

(54) CUSTOMER PREMISES NETWORK ACCESS CONTROL

(71) Applicant: InterDigital Patent Holdings, Inc., Wilmington, DE (US)

(72) Inventors: Xiaoyan Shi, Lake Oswego, OR (US); Taimoor Abbas, Sainte-Julie (CA); Anuj Sethi, Ottawa (CA); Saad Ahmad, Montreal (CA); Debashish Purkayastha, Collegeville, PA (US)

(73) Assignee: InterDigital Patent Holdings, Inc., Wilmington, DE (US)

(21) Appl. No.: 18/693,652

(22) PCT Filed: Oct. 4, 2022
(86) PCT No.: PCT/US22/45641

§ 371 Date: Mar. 20, 2024

Related U.S. Application Data
(60) Provisional application No. 63/253,818, filed on Oct. 8, 2021.

(51) Int. Cl. H04W 12/08; H04W 12/06; H04W 12/72; H04W 60/00

(52) U.S. Cl. CPC H04W 12/08; H04W 12/06; H04W 12/72; H04W 60/00

(57) ABSTRACT

A base station device may include a processor and memory. The base station device may be configured to receive a registration request from a WTRU. The registration request may include an indication that the WTRU is requesting access to a private network. The base station device may send the registration request to a network node. The base station device may receive an identifier of the WTRU from a network node. The base station device may determine whether the WTRU is authorized to access the private network based on the received identifier of the WTRU and a list of allowed device identifiers for the private network. The base station device may send authorization information and an indication that the WTRU has been authorized to access the private network to the network node. The base station device may forward a registration accept message to the WTRU.

### CROSS-REFERENCE TO RELATED APPLICATION

This patent application claims the benefit of U.S. Provisional Patent Application No. 63/253,818, filed on Oct. 8, 2021, which is herein incorporated by reference.

### BACKGROUND

Wireless communication devices, such as wireless transmit/receive units (WTRUs) may establish communications with other devices and data networks, e.g., via a private network, such as a Customer Premises Network (CPN). Accessing such a private network provides a user with further access to the private network's wireless 5G communications capabilities. Smaller, more localized private networks need an efficient means of determining whether a WTRU's request to gain access to the private network should be accepted or rejected.

RAN may refer to a radio access network based on the 5G RAT or Evolved E-UTRA that connects to the NextGen core network. The Access Control and Mobility management function (AMF) may include the following functionalities: registration management, connection management, reachability management, mobility management, etc. The session management function (SMF) may include the following functionalities: session management (including session establishment, modify and release), WTRU IP address allocation, selection and control of UP function, etc. The user plane function (UPF) may include the following functionalities: packet routing & forwarding, packet inspection, traffic usage reporting, etc.

A HeNB subsystem provides LTE access with smaller coverage than macro eNodeB, such as indoor premises and public hotspots. In order to restrict a wireless transmit/receive unit's (WTRU) access to HeNB system, the closed subscriber group (CSG) is used, which identifies a group of subscribers who are permitted to access one or more HeNB cells. The closed subscriber group is configured on both WTRU and WTRU's subscription data in core network. When a WTRU accesses a HeNB, the HeNB will indicate the MME which CSG the WTRU is accessing to, then the MME decides whether the WTRU is allowed to access this HeNB based on the CSG information in WTRU's subscription data.

Customer Premises Network (CPN) is a network located within a premise (e.g. a residence, office or shop), which is owned, installed and/or (at least partially) configured by the customer of a public network operator. evolved Residential Gateway (eRG) is a gateway between the public operator network (fixed/mobile/cable) and a customer premises network. Premises Radio Access Station (PRAS) is a base station installed at a customer premises network.

### SUMMARY

A method performed by a base station configured with a list of allowed General Public Subscription Identifiers (GPSIs) is disclosed. The method comprises: receiving a registration request from a guest wireless transmit/receive unit (WTRU); transmitting the registration request with a customer premises network (CPN) authorization required indication to a access control and mobility management function (AMF); receiving the guest WTRU's GPSI from the AMF; determining whether the guest WTRU is allowed to access the CPN based on a comparison of the guest WTRU's GPSI and the allowed GPSIs; and transmitting a CPN access authorization response to the AMF with an authorization result and authorization information.

A base station device may include a processor and memory. The base station device may be configured to receive a registration request from a WTRU. The registration request may include an indication that the WTRU is requesting access to a private network. The base station device may send the registration request to a network node. The registration request may include an indication of an identifier of the private network. The registration request may include an indication of an authorization request for the WTRU. The indication of an authorization may be sent with the registration request to the network node. The base station device may receive an identifier of the WTRU from a network node. The base station device may determine whether the WTRU is authorized to access the private network based on the received identifier of the WTRU and a list of allowed device identifiers for the private network. The base station device may then send authorization information and an indication that the WTRU has been authorized to access the private network to the network node. The base station device may then forward a registration accept message to the WTRU.

The private network may be a CPN. The identifier may be a generic public subscription identifier (GPSI). The authorization information may include authorization information for the WTRU. The authorization information may indicate one or more of an allowed CPN data name network (DNN) list. The authorization information may indicate an allowed premises radio access station (PRAS) list. The authorization information may indicate an authorization expiry time. The base station device may be configured to receive the information associated with the private network. The information associated with the private network may include the list of allowed device identifiers. The base station device may include a PRAS. The network node may include an AMF. The private network may not be a public land mobile network (PLMN).

The base station device may be configured to receive an indication of a device type of the WTRU from the network node. The base station device may be configured to determine whether the WTRU may be authorized to access the private network based on the device type of the WTRU. The base station device may be configured to receive an authorization credential from the network node before receiving the registration request from the WTRU.

A method performed by the base station device. The method may include receiving a registration request from a wireless transmit/receive unit (WTRU). The registration request may include an indication that the WTRU may be requesting access to a private network. The method may include sending the registration request to a network node. The registration request may include an indication of an identifier of the private network. The registration request may include an indication of an authorization request for the WTRU. The indication of an authorization may be sent with the registration request to the network node. The method may include receiving an identifier of the WTRU from the network node. The method may include determining whether the WTRU may be authorized to access the private network based on the received identifier of the WTRU and a list of allowed device identifiers for the private network. The method may include sending authorization information and an indication that the WTRU has been authorized to access the private network to the network node. The method may include forwarding a registration accept message to the WTRU.

The private network may include a CPN. The identifier may include a GPSI. The authorization information may include authorization information for the WTRU. The method may indicate one or more of an allowed CPN data DNN list; an allowed PRAS list; and/or an authorization expiry time. The method include receiving the information associated with the private network. The information associated with the private network may be including the list of allowed device identifiers. The base station device may be including a PRAS. The network node may be including an AMF. The private network may not be including a PLMN.

The method may include receiving an indication of a device type of the WTRU from the network node. The method may include determining whether the WTRU is authorized to access the private network based on the device type of the WTRU. The method may include receiving an authorization credential from the network node before receiving the registration request from the WTRU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example reference model of a 5G/NextGen network;

FIG. 3 is an example reference model of a HeNB system;

FIG. 4 is an example reference model of a CPN;

FIG. 5 is an is a flow diagram illustrating example PRAS behavior;

FIG. 6 illustrates an example GPSI based authorization procedure;

FIG. 7 illustrates an example guest WTRU's location-based pre-authorization procedure;

FIG. 8 illustrates an example CPN credentials based authorization procedure;

FIG. 9 illustrates an example CPN management function based authorization procedure;

FIG. 10 illustrates an example AMF based authorization procedure;

FIG. 11 is a is a flow diagram illustrating example PRAS behavior;

FIG. 12 is a is a flow diagram illustrating example guest WTRU behavior;

FIG. 13 illustrates an example CPN access discovery procedure; and

FIG. 14 illustrates an example CPN access discovery procedure.

### DETAILED DESCRIPTION

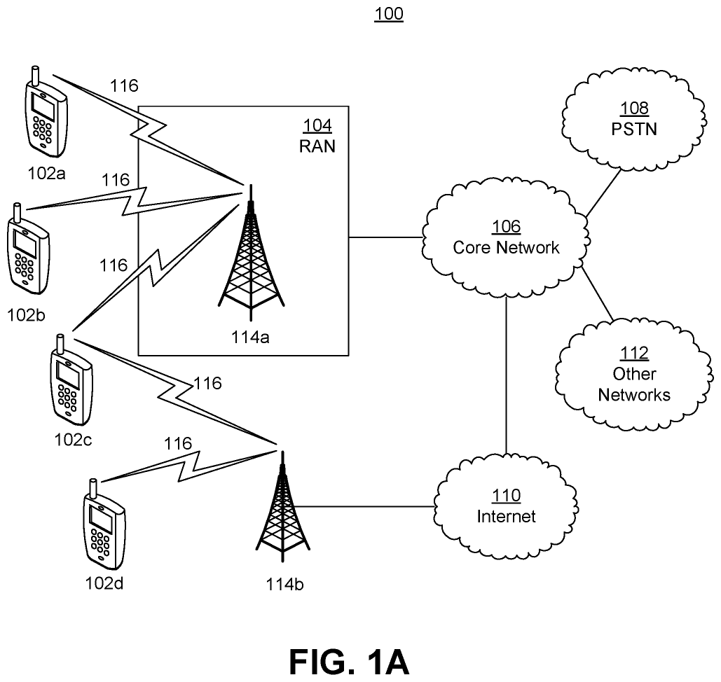

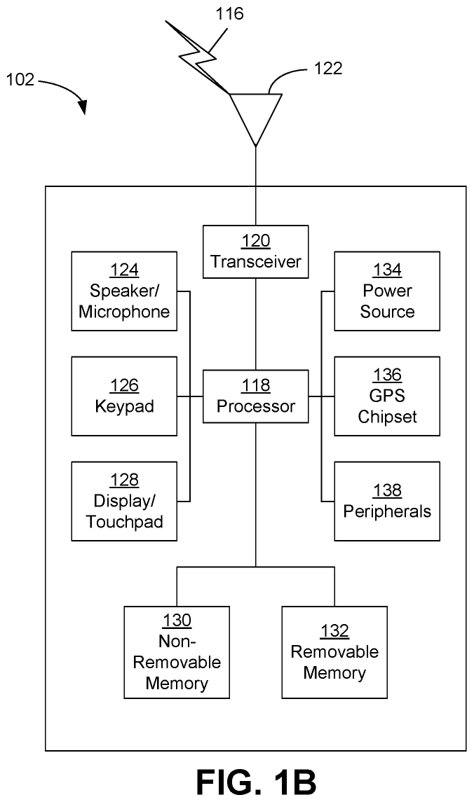

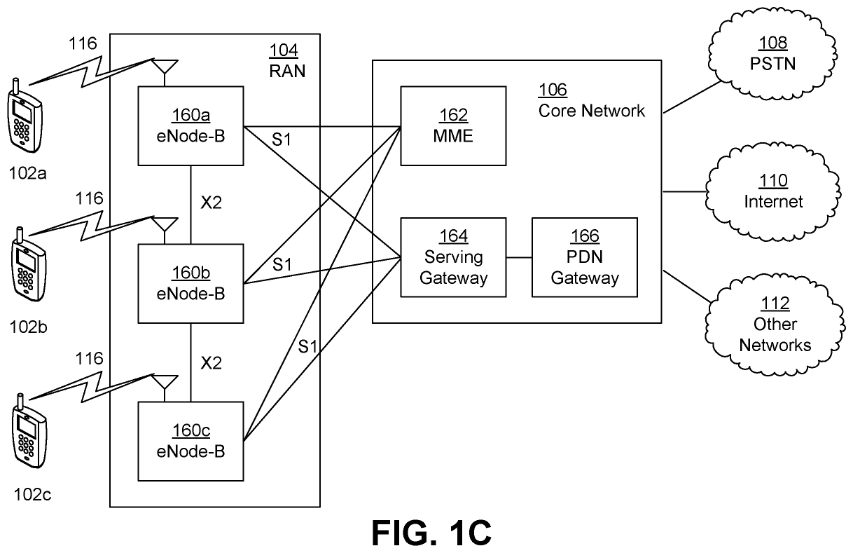

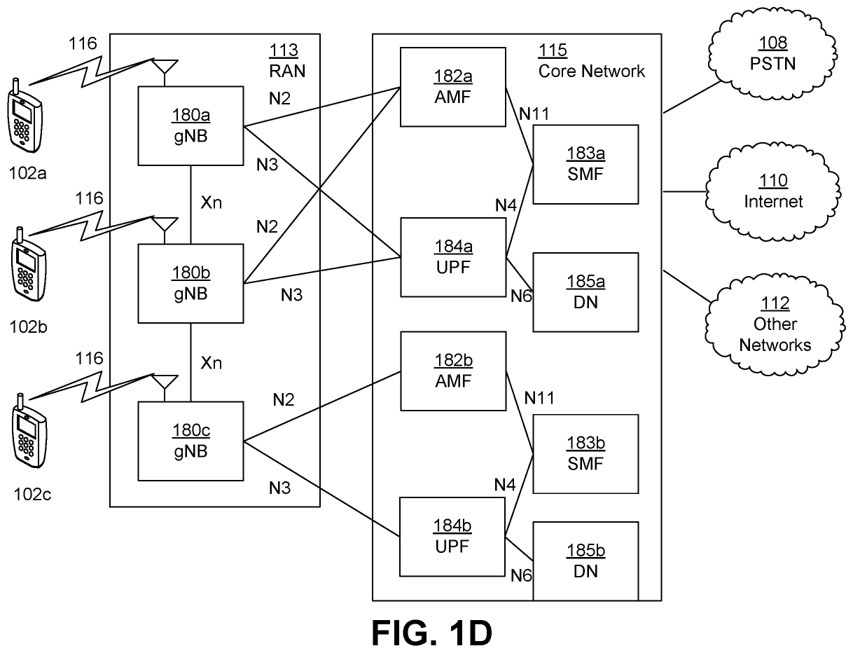

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHZ, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHZ, 2 MHz, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility management function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session management function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

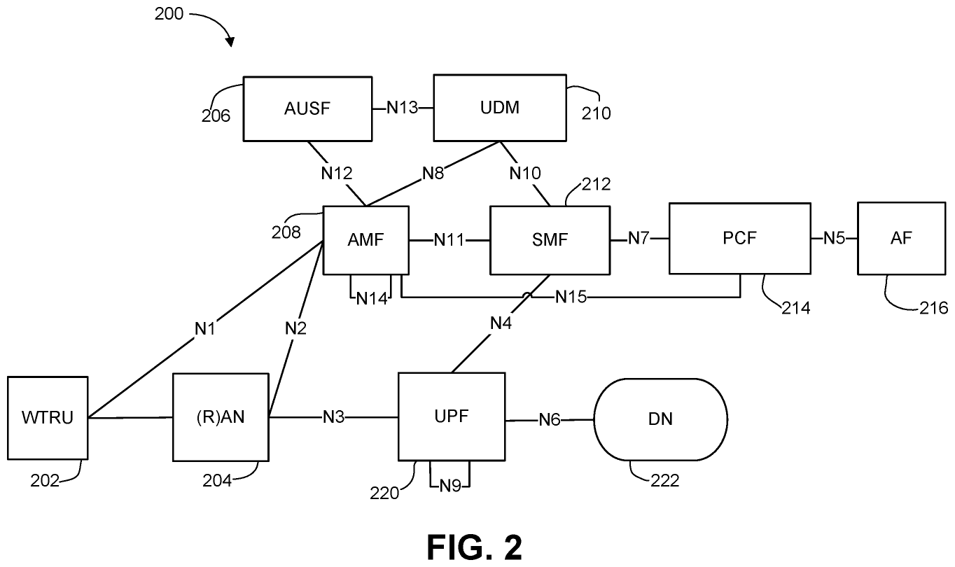

FIG. 2 depicts a reference model 200 of a potential architecture of 5G or NextGen network. The WTRU 202 may connect to a network node, such as the AMF 208, via the N1 interface. The WTRU 202 may connect with the RAN 204. The AMF 208 may include any combination of the following functionalities: registration management, connection management, reachability management, and/or mobility management. The AMF 208 may connect to the RAN 204 by the N2 interface. The AMF 208 may connect to the SMF 212 via the N11 interface. The AMF 208 may connect to the authentic server function (AUSF) 206 via the N12 interface and/or the Unified Data Management (UDM) 210 via the N8 interface. The AUSF 206 and UDM 210 may be connected by the N13 interface.

The SMF 212 may include any combination of the following functionalities: session management (e.g., including session establishment), modify and release WTRU internet protocol (IP) address allocation, and/or selection and control of the UPF 220 The SMF 212 may communicate to the UPF 220 via the N4 interface. The SMF 212 may communicate with the Policy Charging Function (PCF) 214 via an N7 interface and the UDM via the N10 interface. From there, the PCF may be configured to communication with the Application Function (AF 216) via a N5 interface. The UPF 220 may communicate with the RAN 204 via the N3 interface. Moreover, the UPF 220 may connect with the DN 222 via the N6 interface.

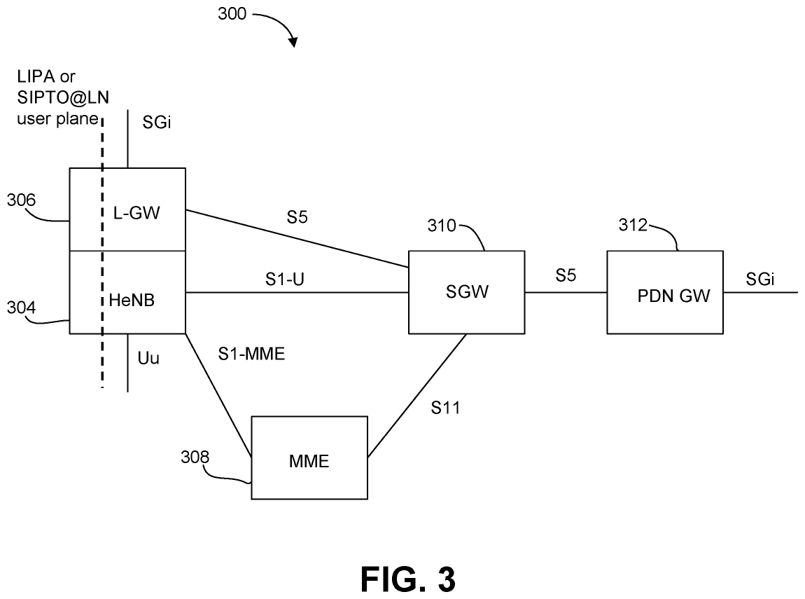

FIG. 3 depicts a Home eNodeB (HeNB) subsystem 300 that may provide LTE access with smaller coverage than macro eNodeB, such as indoor premises and public hotspots. To restrict the WTRU access to the HeNB system 300, the closed subscriber group (CSG) may be used. The CSG may identify a group of subscribers who may be permitted to access one or more HeNB 304 cells. The CSG may be configured on the WTRU and WTRU's subscription data in a core network. When a WTRU accesses a HeNB 304, the HeNB 304 may indicate to the MME 308 via a S1-MME interface which CSG the WTRU is accessing. Then the MME 308 may decide whether the WTRU may access the HeNB 304 based on the CSG information in the WTRU's subscription data.

The HeNB 304 may connect (e.g., directly connect) to the Local Gateway (L-GW) gateway 306. The L-GW 36 may also have direct connectivity to a SGW gateway 310 via the S5 interface. The SGW 310 may further connect to the PDN gateway 312 via a S5 interface. The HeNB 304 may also connect to a SGW 310 via a S1-U interface.

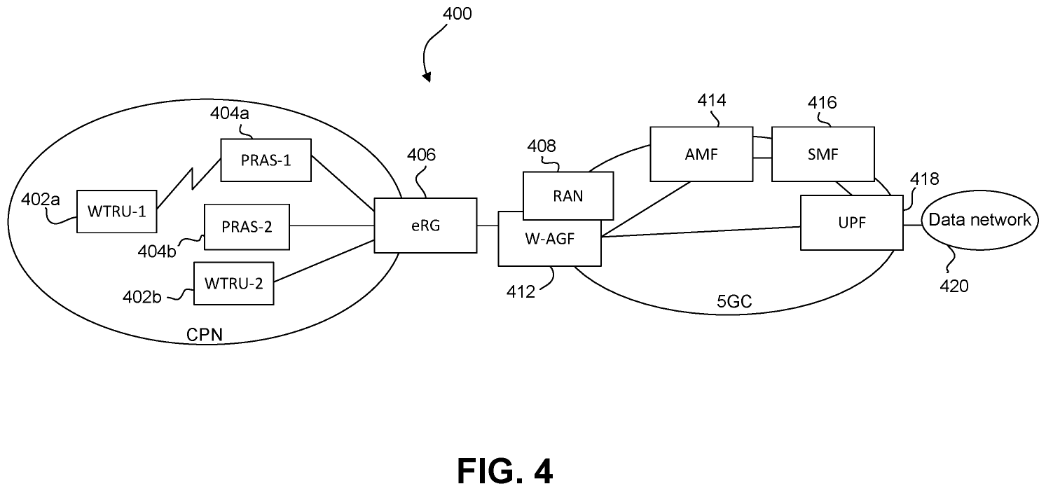

FIG. 4 depicts a system 400 for a private network, such as a CPN, which for example, may be found in a small premise (e.g. a residence, office or shop), and owned, installed and/or (at least partially) configured by the customer of a public network operator. The eRG 406 may be a gateway between the public operator network (fixed/mobile/cable) and CPN. PRAS-1 404a may be a base station installed at a private network, such as a CPN. FIG. 4 illustrates that the WRTU-1 402a may communicate to the eRG 406 via PRAS-1 402a. FIG. 4 further demonstrates that in some embodiments the WRTU 402b may directly communicate with the eRG 406 independently of PRAS-2 402b. The eRG 406 may connect to the wireless access gateway function (W-AGF) 412. The W-AGF 412 may connect with the RAN 408, AMF 414, SMF 416, and/or UPF 418. The SMF 416 also may be configured to communication with the UPF 418. The UPF 418 may have additional connectivity to DN 420.

A network node, such as the AMF 414 (e.g., and/or MME), may determine whether a specific WTRU is allowed to access a local network, e.g. Public Network Integrated NPN, Home eNB system. The network node may make this determination based on the WTRU's subscription which is stored in core network, e.g. UDM. Considering a CPN case, a guest WTRU may be allowed to access the CPN temporally by the CPN owner. In some examples, it may not be recommended to allow a CPN's owner to update guest WTRU's subscription stored in core network, since the update may cause serious security problem and subscription data server overload due to frequent update.

A WTRU may discover a local network by the local network ID broadcasted by the local network, e.g. CAG ID, CSG ID. The WTRU may determine whether the local network is permitted to access based on the configured allowed local network ID list. For example, the WTRU may be configured with an Allowed CAG list (e.g., by AMF based on the WTRU's subscription) when the WTRU registered to its PLMN. Considering a CPN case, a guest WTRU may be allowed to access the CPN temporally by the CPN owner. In some examples, there may not be corresponding subscription data and therefore it may be impossible to configure WTRU by its PLMN when the WTRU registered.

Methods may be provided herein to allow for CPN access authorization by one or more WTRUs (e.g., guest WTRUs). For example, in some examples, the PRAS may be configured with a list of allowed identifiers, such as a GPSI. When receiving registration request from the guest WTRU-1 the PRAS may receive a registration request from the guest WTRU-1. The PRAS may send the CPN an authorization required indication with guest WTRU-1's registration request to a core network. A core network (e.g. AMF) sends CPN Access authorization request to PRAS-1, which includes the guest WTRU-1's identifier (e.g., GPSI). The PRAS-1 may determine whether the guest WTRU may be allowed to access to the CPN based on the guest WTRU's identifiers and configured the list of allowed identifiers. The PRAS-1 may send CPN Access authorization response to a core network (e.g. AMF). After receiving authorization response, the core network (e.g. AMF) may send a registration message to accept or reject the guest WTRU.

The list of allowed identifiers (e.g., GPSIs) may be configured to eRG. In this case, the PRAS-2 may forward CPN Access authorization request to eRG or the core network (e.g. AMF) sends CPN Access authorization request to eRG directly. After eRG determines whether the guest WTRU-2 is allowed to access the CPN based on guest WTRU-2's identifier and configured the list of allowed identifiers, the eRG sends CPN an Access authorization Response to PRAS. PRAS then forwards the authorization response to the core network (e.g. AMF) or the eRG sends the CPN Access authorization Response to core network (e.g. AMF) directly.

Corresponding authorization information may be configured to PRAS-1, PRAS-2, or eRG for allowed GPSI, for example, allowed CPN DNN list, allowed PRAS list, and/or authorization expire time. This authorization information may be provided to core network by the PRAS-1, the PRAS-2, and/or the eRG if the guest WTRU is allowed to access CPN. The CN (e.g. AMF) may send the authorization information to the guest WTRU via non-access stratum NAS signaling. The base station device(s) (e.g. the PRAS-1, the PRAS-2, and/or the eRG) may also be configured with the allowed guest WTRU-1 or WTRU-2 device type, e.g. IoT device, media player device. In these cases, the AMF may provide the guest WTRU-1 or WTRU-2 device type in CPN Access authorization request to PRAS-1 or WTRU-2 or eRG. The PRAS-1 or WTRU-2 or eRG determines whether the guest WTRU-1 or WTRU-2 may be allowed to access the CPN based on the guest WTRU-1's or WTRU-2's device type.

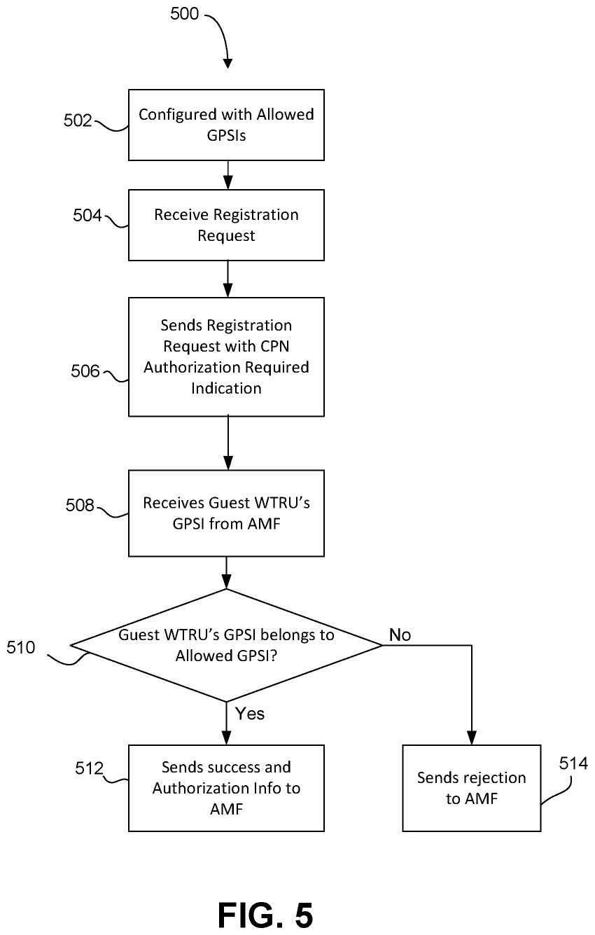

FIG. 5 is a system 500 illustrating base station, such as the PRAS, behavior. At 502, the PRAS may be configured with allowed identifiers (e.g., a list of allowed identifiers) and corresponding authorization information. The identifier(s) may include a GPSI(s). The PRAS may include a processor and memory.

The processor and memory may be configured to receive a registration request from a WTRU. For example, at 504, the system 500 may receive a registration request from a guest WTRU. The registration request may include an indication that the WTRU is requesting access to a private network. The PRAS may send the registration request to a network node. The registration request may include an indication of an identifier of the private network. The registration request may include an indication of an authorization request for the WTRU.

For example, at 506, the PRAS may send the private network, such as a CPN, an authorization required indication with guest WTRU's registration request to the network node, such as an AMF. The PRAS may receive an identifier of the WTRU from a network node.

For example, at 508, the PRAS may receive a CPN access authorization request from the AMF, which may include a guest WTRU's identifier (e.g., a GPSI associated with the guest WTRU). The PRAS may determine whether the WTRU may be authorized to access the private network based on the received identifier of the WTRU and a list of allowed device identifiers for the private network.

For example, at 510, the PRAS may determine whether the guest WTRU is allowed to access the CPN based on the allowed identifiers and the guest WTRU's identifier. For example, the PRAS may compare the guest WTRU's identifier (e.g., the guest WTRUs GPSI) with the allowed identifiers (e.g., the list of allowed identifiers, such as the list of allowed GPSIs). The PRAS may then send authorization information and an indication that the WTRU has been authorized to access the private network to the network node.

For example, the PRAS may send a CPN access authorization response to the AMF with the authorization result and corresponding authorization information. The authorization information may indicate one or more of an allowed CPN data name network (DNN) list. The authorization information may indicate an allowed premises radio access station (PRAS) list. The authorization information may indicate an authorization expiry time. The PRAS may then forward a registration accept message to the WTRU. For example, if the PRAS determines that the guest WTRU belongs to (e.g., matches) an identifier within the allowed identifiers, the PRAS may send an authentication (e.g., success and authorization information) to the AMF at 512. If the PRAS determines that the guest WTRU does not belong to (e.g., does not match) an identifier within the allowed identifiers, the PRAS may send a rejection to the AMF at 514.

Similarly, the eRG may be configured with allowed identifier and corresponding authorization information (e.g., at 502). As noted above, the identifier may include a GPSI. The eRG may receive the CPN access authorization request from the PRAS (or from AMF) for a guest WTRU (e.g., at 504). The eRG may send the CPN access authorization response to the PRAS (or to the AMF) for guest WTRU with the authorization result and corresponding authorization information (e.g., at 506).

The AMF may receive the CPN authorization required indication with a the guest WTRU's registration request. The AMF may retrieve the guest WTRU's identifier from subscription data. The AMF may send the CPN access authorization request to PRAS (e.g., at 508), which, as noted above, may include the guest WTRU's identifier (e.g., the guest WTRUs GPSI). The AMF may receive the CPN access authorization response with the authorization result and corresponding authorization information. The AMF may send the registration response to the guest WTRU, which includes authorization information.

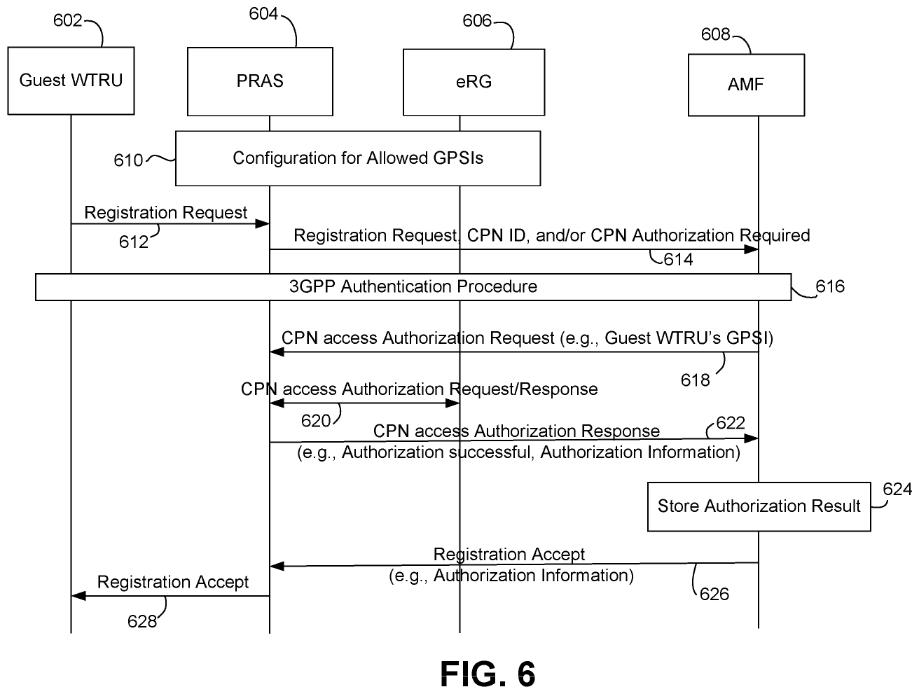

FIG. 6 illustrates an identifier-based authorization procedure, which includes authorization of an identifier (e.g., GPSI). The authorization procedure may be performed by any combination of a WTRU, such as a guest WTRU 602, one or more base station devices, such as a PRAS 604 and/or an eRG 606, and/or a network node, such as an AMF 608. The authorization procedure may be performed by the base station device (e.g., the PRAS 604 and/or the eRG 606) to authorize the guest WTRU 602 to access a private network, such as a CPN.

At 610, the base station device(s) (e.g., the PRAS 604 and/or the eRG 606) may be configured with allowed identifiers and corresponding authorization information. The PRAS 604 may be configured to receive an indication of a device type of the WTRU from the network node (e.g. the AMF). The PRAS 604 may be configured to determine whether the WTRU may be authorized to access the private network based on the device type of the WTRU. In some examples, the base station device may be configured to receive an authorization credential from the network node before receiving the registration request from the WTRU. At 612, the PRAS 604 may receive a registration request from the guest WTRU 602. In some examples, the registration request may be sent via a Radio Resource Control (RRC) message to the PRAS 604. In some examples, the PRAS 604 may be able read the RRC part of the registration request message (e.g., only ready the RRC part of the registration request message). At 614, the PRAS 604 may send a CPN ID and/or a CPN authorization required indication with the guest WTRU 602's registration request to a network node, such as the AMF 608 (e.g. over the N2 or similar message to the AMF).

The base station device(s) (e.g., the PRAS 604 and/or the eRG 606) may perform 3GPP authentication to authorize the guest WTRU 602 to access a private network. At 618, the AMF 608 may retrieve the guest WTRU 602's identifier and send a CPN access authorization request to the PRAS 604. The CPN access authorization request may include the guest WTRU's identifier (e.g., GPSI). At 620, the PRAS 604 may send a CPN access authorization request to the eRG 606 if, for example, the allowed identifier is configured on the eRG 606. The PRAS 604 (e.g., and/or eRG 606) may determine whether the guest WTRU 602 is allowed to access CPN based on the allowed identifier and the guest WTRU 602's identifier. At 622, the PRAS 604 (e.g., and/or eRG 606) may send a CPN access authorization response to the AMF 608. station device may be configured to determine whether the WTRU may be authorized to access the private network based on the device type of the WTRU The CPN access authorization response may include an authorization result and/or authorization information. At 624, the AMF 608 may store the authorization result and/or authorization information. At 626, the AMF 608 may send a registration accept message to the PRAS 604. The registration accept message may include authorization information. At 628, the PRAS 604 may forward the registration accept to the guest WTRU 602. The guest WTRU 602 may be authorized to access the private network (e.g., the CPN).

In some examples, the guest WTRU 602 may receive configurations from the AMF 608, for example, before the guest WTRU 602 loses connection with the home public land mobile network HPLMN and/or enters poor coverage, including the details about the available CPNs in that area. The AMF 608 may configure the guest WTRU 602 while it is connected to the HPLMN for seamless connection to a nearby CPN. The AMF 608 may configure the PRAS 604 (e.g., and/or the eRG 606) with an authorization configuration for the guest WTRU, for example, so the PRAS 604 (e.g., and/or eRG 606) can authorize the guest WTRU 602 upon reception of a registration request with valid authorization credentials.

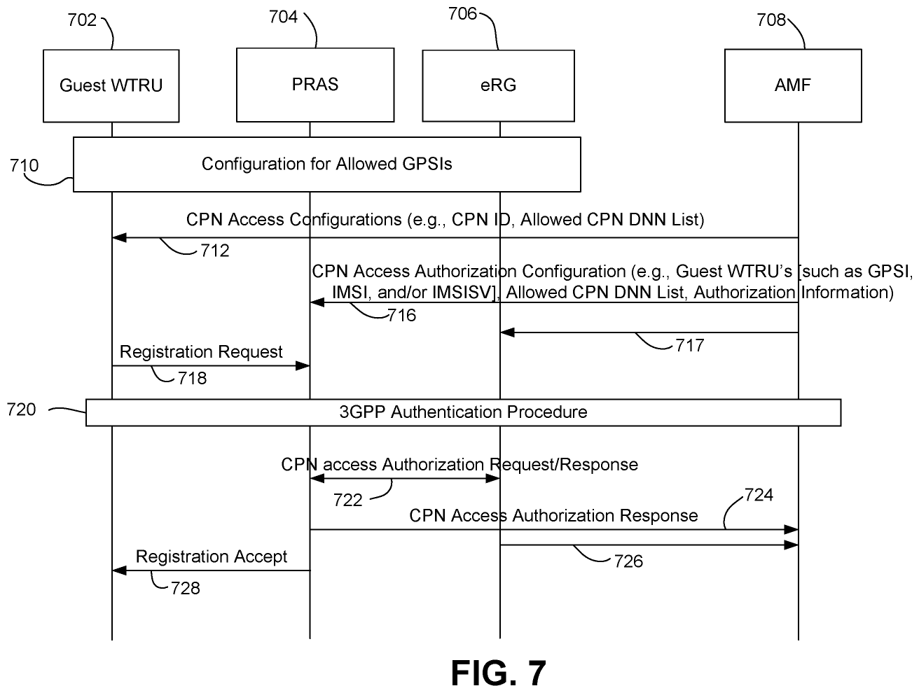

FIG. 7 illustrates a guest WTRU 702's location-based pre-authorization procedure. As shown at 710, the private network (e.g. a CPN) may be configured with allowed identifiers (e.g., GPSIs) and corresponding authorization information. At 712 the network node (e.g. an AMF 708) may send available CPN access configurations to the guest WTRU 702 including the CPN ID, allowed CPN DNN list and pre-authorization info. The AMF 708 may send this info to the guest WTRU 702 based on the guest WTRU 702 subscription profile, and/or guest WTRU 702's location. Optionally, the AMF 708 may receive an explicit indication from the guest WTRU 702 requesting the CPN information. At 716 and 717 the AMF 708 may send CPN access authorization configuration to the PRAS 704 or eRG 706, respectively, in advance. The AMF 708 may further send information related to the guest WTRU 702's authorization including guest WTRU 702's allowed CPN DNN list, and/or authorization information, such as GPSI, international mobile subscriber identity (IMSI), and/or IMSI software version (IMSISV). At 718, the guest WTRU 702 may send a registration request to the PRAS 704. Optionally, at 720, 3GPP authentication is performed. At 722, the PRAS 704 may forward the CPN access authorization request to eRG 706 if the CPN's credentials are configured on eRG 706.

The PRAS 704 (or eRG 706) may determine whether the guest WTRU 702 may be allowed to access CPN based on received CPN's credentials and configured CPN's credentials. At 724, the PRAS 704 may send a CPN access authorization response to the AMF 708, which includes an authorization result and authorization information. At 726, the eRG 706 may send a CPN access authorization response to the AMF 708, which includes an authorization result and authorization information. Then, at 728, the PRAS 704 may forward a registration accept to the guest WTRU 702.

At 712, the AMF 708 may send CPN access configuration to the guest WTRU 702 including CPN ID, allowed CPN DNN list and pre-authorization information. At 716, the AMF 708 may send a CPN access authorization configuration to the PRAS 704, which includes the CPN's credentials. At 717, the AMF 708 may send a CPN access authorization configuration to the eRG 706, which includes the CPN's credentials. At 724, the AMF 708 may receive a CPN access authorization response from the PRAS 704 and at 726 the AMF 708 may receive a CPN access authorization from the eRG 706. In some examples, the authorization response may include the authorization result and/or corresponding authorization information.

At 710, the PRAS 704 (or eRG 706) may be configured with the CPN's credentials and corresponding authorization information. At 718 the PRAS 704 (or eRG 706) may receive a registration request from the guest WTRU 702. The PRAS 704 (or eRG 706) may receive pre-authorization information i.e. CPN access authorization configuration from the AMF 708, which includes the guest WTRU 702's and CPN's credential. At 718 the PRAS 704 (or eRG 706) may determine whether the guest WTRU 702 may be allowed to access a CPN based on the received guest WTRU 702's and CPN's credentials and configured CPN's credentials. At 724, the PRAS 704 may send a CPN access authorization response to the AMF 708 with the authorization result and corresponding authorization information. At 726, the eRG 706 may send a CPN access authorization response to the AMF 708 with the authorization result and corresponding authorization information.

At 710, the guest WTRU 702 may be configured with the CPN's credential, e.g. via core network (PCF). At 716, the guest WTRU 702 may receive authorization configurations from the AMF 708 with pre-authorization info for a specific CPN including CPN ID and CPN DNN list. At 718, the guest WTRU 702 may send a registration request to the PRAS 704, which includes CPN's credentials. At 728, the guest WTRU 702 may receive a registration accept from the PRAS 704.

In some examples, at 710, both guest WTRU 702 and PRAS 704 may be configured with CPN's credential (e.g. CPN's Certificate, CPN's password, allowed CPN DNN list). The guest WTRU 702 may include the CPN's credential in registration request. The PRAS 704 may send a CPN authorization required indication with guest WTRU 702's registration request. The core network (e.g. AMF 708) may send a CPN access authorization request to the PRAS 704, which includes the received CPN's credential. The PRAS 704 determines whether the guest WTRU 702 may be allowed to access the CPN based on received CPN's credential and configured CPN's credential. At 728, the PRAS 704 sends a CPN access authorization response to core network (e.g. AMF 708).

The CPN's credential may be configured to eRG 706. The PRAS 704 forwards CPN access authorization request to eRG 706. After the eRG 706 determines whether the guest WTRU 702 is allowed to access the CPN based on received CPN's credential and configured CPN's credential, the eRG 706 sends a CPN access authorization response to the PRAS and the PRAS forwards it to the core network (e.g. AMF 708).

At 710, the PRAS 704 or eRG 706 may also be configured with the allowed guest WTRU 702 device type, e.g. IoT device, media player device, and the like. In this case, the AMF 708 may provide the guest WTRU 702 device type in the CPN access authorization request to the PRAS 704 or eRG 706. The PRAS 704 or eRG 706 determines whether the guest WTRU 702 is allowed to access the CPN based on the guest WTRU 702's device type.

Multiple CPN credentials may be configured to PRAS 704. Each of the CPN's credentials may be configured with corresponding authorization information, for example, allowed CPN DNN list, allowed PRAS list, authorization expire time. This authorization information may be provided to core network by PRAS 704 if the guest WTRU 702 is allowed to access CPN.

At 710, the PRAS 704 may be configured with the CPN's credential and corresponding authorization information. At 718, the PRAS 704 may receive a registration request from the guest WTRU 702. The PRAS 704 may send a CPN authorization required indication with guest WTRU 702's registration request to AMF 708. The PRAS 704 may receive a CPN access authorization request from the AMF 708, which includes the CPN's credential. The PRAS 704 may determine whether the guest WTRU 702 is allowed to access the CPN based on the received CPN's credential and configured CPN's credential. The PRAS 704 may send the CPN access authorization response to the AMF 708 with the authorization result and corresponding authorization information.

At 710, the guest WTRU 702 may be configured with the CPN's credential, e.g. manually or received from the CPN. The guest WTRU 702 may send the registration request to the AMF 708 via PRAS, which includes CPN's credential. The guest WTRU 702 may receive a registration accept from the AMF 708.

At 710, the eRG 706 may be configured with a CPN's credential and corresponding authorization information. At 722 the eRG 706 may receive a CPN access authorization request from the PRAS 704 (or from the AMF 708) for a guest WTRU 702. At 726, the eRG 706 may send a CPN access authorization response to the PRAS 704 (or to the AMF 708) for a guest WTRU 702 with the authorization result and corresponding authorization information.

The AMF 708 may receive a CPN authorization required indication and the CPN's credential from a guest WTRU 702's registration request. The AMF 708 may send a CPN access authorization request to PRAS 704, which includes the CPN's credential. The AMF 708 may receive a CPN access authorization response with the authorization result and corresponding authorization information. The AMF 708 may send a registration response to the guest WTRU 702, which includes authorization information.

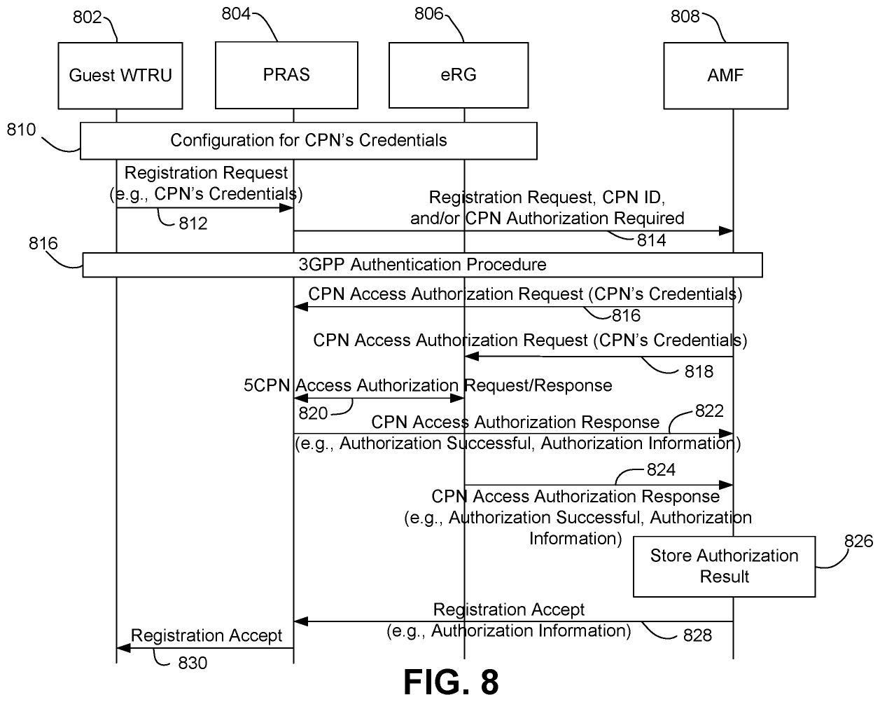

FIG. 8 illustrates a private network (e.g., a CPN) credential-based authorization procedure. At 810, the private network (e.g. the CPN) and guest WTRU 802 may be configured with a CPN's credentials and corresponding authorization information. At 812, the guest WTRU 802 may send a registration request to the base station device (e.g. the PRAS 804), which includes the CPN's credentials. At 814, the PRAS 804 may send a CPN ID and CPN authorization required indication with the guest WTRU 802's registration request to AMF 808. Next, at 816 a 3GPP authentication may be performed. In some examples, at 816, the network node (e.g. the AMF 808) may send the CPN access authorization request to the PRAS 804, where in CPN access authorization may include the received CPN's credentials. In some examples, as seen at 818, the AMF 808 may send CPN access authorization request to the eRG 806 directly, wherein the CPN access authorization may include received CPN's credentials. At 820, the PRAS 804 may forward CPN Access authorization request to the eRG 806 if the CPN's credentials is configured on eRG 806. The PRAS 804 (or the eRG 806) may determine whether the guest WTRU 802 is allowed to access CPN based on received CPN's credentials and configured CPN's credentials. Then, at 822, the PRAS 804 may send CPN access authorization response to the AMF 808, which includes authorization result and authorization information. Alternatively, the eRG 806 sends CPN access authorization response to the AMF 808, which includes authorization result and authorization information. At 826, the AMF 808 may store the authorization result and authorization information. At 828, the AMF 808 may send the registration accept message to PRAS 804, which includes authorization information. At 830, the PRAS 804 may forward the registration accept to the guest WTRU 802.

For example, the CPN (e.g. the PRAS 804 or the eRG 806) may be configured with a list of allowed identifiers, such as a GPSI. The CPN (e.g. the PRAS 804 or the eRG 806) registers the CPN identifier and allowed identifiers to the CPN management function. The CPN management function may either be part of the 3GPP Core Network or may be an external function which communicates with the 3GPP network via the network exposure function (NEF). At 814, the PRAS 804 receives a registration request from the guest WTRU 802 and then sends the CPN authorization required indication and/or the CPN identifier and the CPN management function address with guest WTRU 802's registration request. At 816, the core network (e.g., AMF 808) sends the CPN access authorization request to the CPN management function, which may include a CPN identifier and guest WTRU 802's identifier. The CPN management function may determine whether the guest WTRU 802 may be allowed to access the CPN based on CPN identifier and guest WTRU 802's identifier and other allowed identifiers. At 824, the CPN management function may send a CPN access authorization response to the core network (e.g., AMF 808).

At 810, corresponding authorization information may be configured to PRAS 804 or eRG 806 for allowed identifiers, for example, GPSIs, allowed CPN DNN list, allowed PRAS 804 list, and/or authorization expire time. This authorization information may be registered to CPN management function with CPN identifier. The CPN management function may be located in CPN or core network or external network. The AMF 808 may communicate with CPN management function directly, via NEF, via PCF, etc., which depends on the CPN management function's location. Before the CPN registers to CPN management function, the CPN may be configured with the CPN's address and/or fully qualified domain name (FQDN).

At 810, the base station, such as the PRAS 804, may be configured with allowed identifiers, such as the GPSI, and corresponding authorization information. A PRAS 804 may register the CPN identifier and allowed identifiers and corresponding authorization information to CPN management function. At 812, a PRAS 804 may receive a registration request from the guest WTRU. At 814, a PRAS 804 may send a CPN authorization required indication with guest WTRU 802's registration request to AMF 808, optionally, with CPN management address.

The network node, such as the AMF 808, may receive a CPN authorization required indication and CPN identifier with guest WTRU 802's registration request, optionally with CPN management function address. The AMF 808 may retrieve the CPN management address if the PRAS 804 does not receive the CPN management function address. At 816, the AMF 808 may send a CPN access authorization request to CPN management function, which includes guest WTRU 802's identifier, and/or CPN identifier. At 822, the PRAS 804 may send the AMF 808 a CPN access authorization response with the authorization result and corresponding authorization information. Similarly, at 824, the PRAS 804 may send the AMF 808 a CPN access authorization response with the authorization result and corresponding authorization information. The AMF may send a registration response to the guest WTRU 802, which includes authorization information.

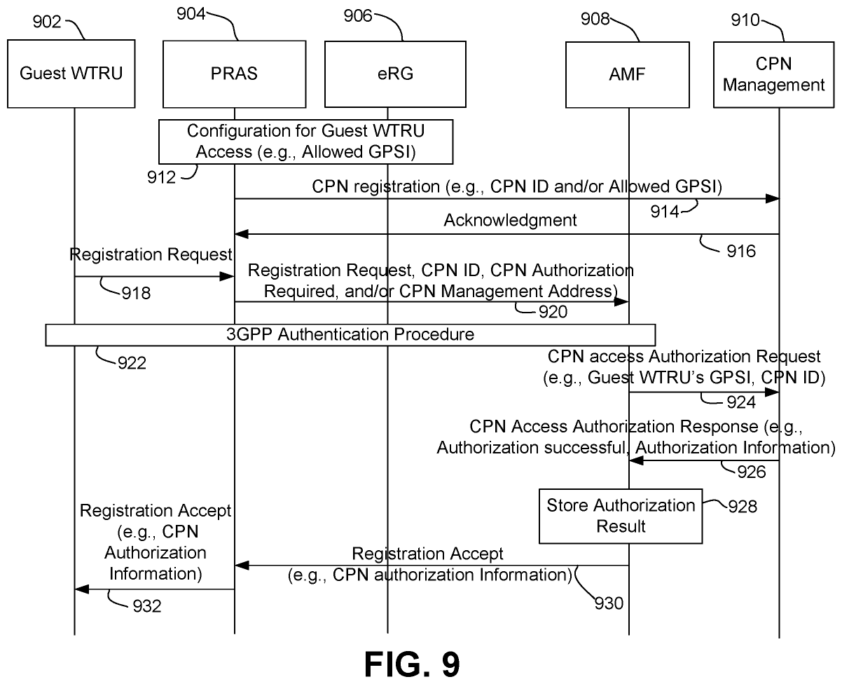

FIG. 9 illustrates a CPN management function-based authorization procedure. At 912 the private network (e.g. the CPN, such as the PRAS 904 and/or the eRG 906) may be configured with allowed identifiers (e.g., GPSIs) and corresponding authorization information. At 914, the CPN (e.g., PRAS 903 and/or eRG 906) may register CPN identifiers, such as allowed GPSIs, and corresponding authorization information to the CPN management function 910. The registration may happen over a user plane between the PRAS 904 and the CPN management function 910. At 916, the CPN management function 910 may send a registration acknowledgement message to the PRAS 904. At 918, the guest WTRU 902 sends a registration request to the PRAS 904. At 920, the PRAS 904 may send a CPN ID and a CPN authorization required indication with a guest WTRU 902's registration request to the network node, (e.g. the AMF 908), optionally, with CPN management function 910 address. Next, at 922, 3GPP authentication may be performed. At 924, the AMF 908 may retrieve a guest WTRU 902's identifier and send CPN access authorization request to CPN management function 910 (e.g. directly, via NEF, and/or via PCF, and the like), which includes guest WTRU 902's identifier and CPN identifier. The CPN management function 910 may determine whether the guest WTRU 902 is allowed to access the CPN based on allowed identifiers and guest WTRU 902's identifier and/or CPN identifier. At 926, CPN management 910 function may send CPN access authorization Response to AMF 908 (e.g., directly, via NEF or via PCF, etc.) which includes authorization result and authorization information. At 928, the AMF 908 may store the authorization result and authorization information. At 930, the AMF 908 may send registration accept message to PRAS 904, which includes authorization information. At 932, the PRAS 904 may forward a registration accept to the guest WTRU 902.

At 912, the PRAS 904 may be configured with a list of allowed identifiers (e.g., GPSIs). At 918, after receiving registration request from the guest WTRU 902, the PRAS 904 at 920 sends the list of allowed identifiers with guest WTRU 902's registration request. The core network (e.g. AMF 908) retrieves guest WTRU 902's identifier and determines whether the guest WTRU 902 is allowed to access the CPN based on guest WTRU 902's identifier and received list of allowed identifiers.

The corresponding authorization information may be configured to the PRAS 904 or the eRG 906 for allowed identifier, for example, allowed GPSIs, allowed CPN DNN list, allowed PRAS list, and/or authorization expire time. This authorization information may be provided to core network by the PRAS 904 with the list of allowed identifiers.

At 912, the PRAS 904 may be configured with allowed identifier and corresponding authorization information. At 918, the PRAS 904 may receive a registration request from the guest WTRU 902. At 920, the PRAS 904 may send allowed identifiers and corresponding authorization information with guest WTRU 902's registration request to AMF 908.

The AMF 908 may receive allowed identifiers, such as GPSIs, with guest WTRU 902's registration request 918. The AMF 908 may retrieve a guest WTRU 902's identifier from the subscription data. The AMF 908 may determine whether the guest WTRU 902 can access CPN based on allowed GPSIs and/or guest WTRU's GPSIs. The AMF 908 may send a registration response to the guest WTRU 902, which includes authorization information.

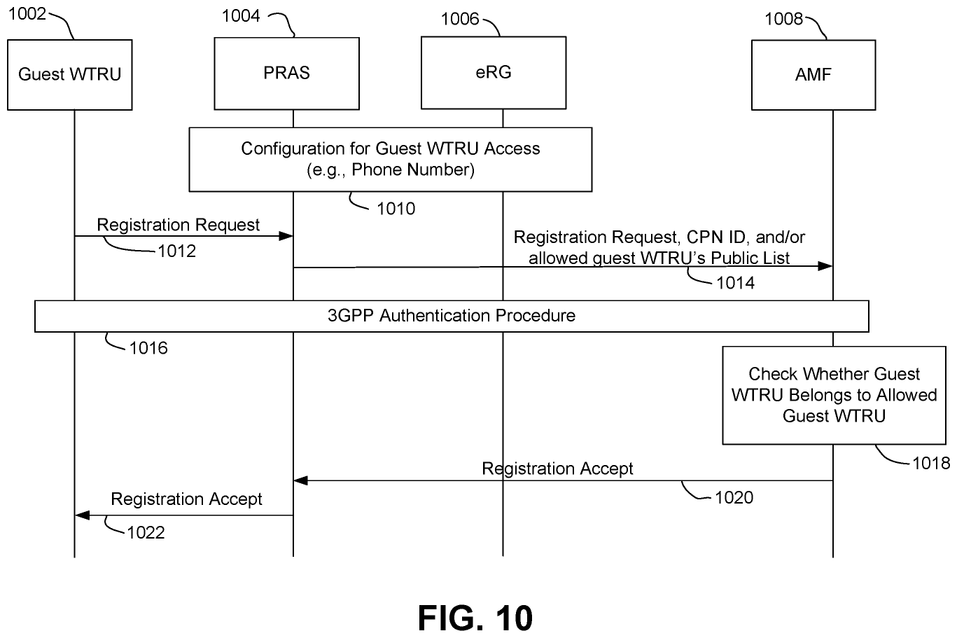

FIG. 10 illustrates an AMF-based authorization procedure. At 1010, the private network (e.g. the CPN) may be configured with allowed identifiers (e.g., GPSIs) and corresponding authorization information. At 1010, the guest WTRU 1002 may send a registration request to the base station, (e.g. the PRAS 1004). At 1014, the PRAS 1004 may send a CPN ID and allowed identifiers and corresponding authorization information with guest WTRU 1002's registration request to the network node, (e.g. the AMF 1008). At 1016, 3GPP authentication may be performed. Then at 1018, the AMF 1008 may retrieve a guest WTRU 1002's identifier. After retrieving the guest WTRU 1002's identifier, the AMF 1008 may determine whether the guest WTRU 1002 can access CPN based on allowed identifiers and guest WTRU 1002's identifier. At 1020, the AMF 1008 may send a registration accept message to the PRAS 1004, which includes authorization information. At 1022, the PRAS 1004 may forward the registration accept to guest WTRU 1002.

At 1010, the PRAS 1004 may be configured with a list of allowed identifiers. The PRAS 1004 request corresponding 3GPP ID, e.g. 5G-GUTI for each allowed identifier from the core network. When receiving corresponding 3GPP IDs for allowed GPSI, the PRAS 1004 broadcasts corresponding 3GPP IDs in a cell broadcast message. When a guest WTRU 1002 receives a cell broadcast message, the guest WTRU 1002 may determine whether it can access the PRAS 1002 based on guest WTRU 1002's 3GPP ID and 3GPP IDs in cell broadcast message. The 3GPP IDs may be hashed using a hashing technique (e.g. 5G globally unique temporary identifier (5G-GUTI) for privacy protection.

At 1010, the PRAS 1004 may be configured with allowed identifier(s), which may include GPSIs. The PRAS 1004 may send a WTRU's 3GPP ID request which may include allowed GPSIs. The PRAS 1004 may receive a hashed WTRU's 3GPP ID which may correspond to an allowed identifier, including any corresponding GPSIs. The PRAS 1004 may broadcast the hashed WTRU 1002's 3GPP ID which corresponds to an allowed identifier, including any corresponding GPSIs. The guest WTRU 1002 may monitor the broadcasted hashed WTRU 1002's 3GPP ID. The guest WTRU 1002 may determine whether the guest WTRU 1002 can access the PRAS 1004 based on the guest WTRU 1002's 3GPP ID and/or 3GPP IDs in a cell broadcast message.

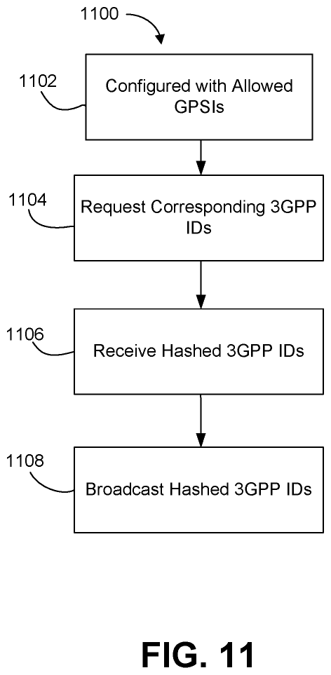

FIG. 11 depicts a system 1100 describing PRAS behavior. At 1102, the base station (e.g. the PRAS) may be configured with the list of allowed identifiers (e.g., GPSIs). At 1104, the PRAS may request from the guest WTRU 3GPP ID. At 1106, the PRAS may then receive 3GPP IDs, which may be hashed, from a guest WTRU. At 1108, the PRAS 1104 may broadcast the 3GPP IDs, which may be hashed. The 3GPP IDs may correspond to an allowed identifier, including any corresponding GPSIs.

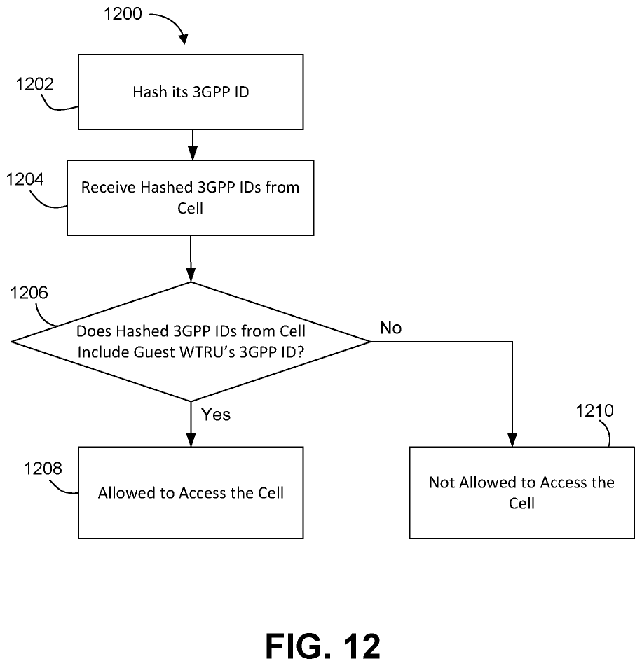

FIG. 12 depicts a system 1200 which describes guest WTRU behavior. At 1202, the guest WTRU may hash a 3GPP ID. At 1204, the guest WTRU may receive a list of allowable hashed 3GPP IDs. At 1206, the guest WTRU may determine if the list of hashed 3GPP IDs received from the cell and/or determine if the list of 3GPP IDs includes the 3GPP ID hashed at 1202. If the list of 3GPP IDs includes the guest WTRU's 3GPP ID, then the WTRU may be allowed to access the cell at 1208. If the list of 3GPP IDs does not include the guest WTRU's 3GPP ID, the WTRU may not be allowed to access the cell at 1210.

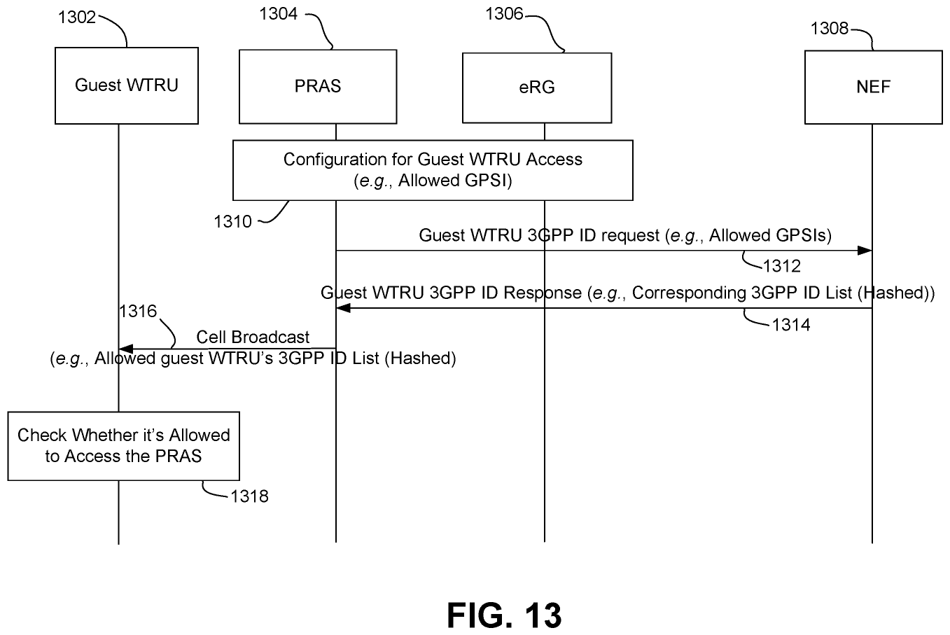

FIG. 13 illustrates an example of CPN access discovery. At 1310, the base station (e.g. the PRAS 1304) may be configured with allowed identifiers. At 1312, the PRAS 1304 may send a guest WTRU 1302 3GPP ID request to NEF 1308, which includes allowed identifiers. At 1314, the NEF 1308 may retrieve a corresponding 3GPP ID and sends hashed 3GPP IDs to the PRAS 1304. At 1316, the PRAS 1304 may broadcast received hashed 3GPP IDs. At 1318 the guest WTRU 1302 may receive a broadcasted hashed WTRU 1302's 3GPP ID and determine whether it can access the PRAS 1304 based on hashed guest WTRU 1304's 3GPP ID and hashed WTRU's 3GPP IDs in cell broadcast message

At 1310, the PRAS 1308 may be configured with the list of allowed identifiers, such as GPSIs. The PRAS 1304 may support hashed 3GPP IDs and broadcasts this support via cell broadcast. The guest WTRU 1302 (e.g., which may not support the hashed 3GPP IDs feature) may listen to the cell broadcast from PRAS 1304. In some examples, the guest WTRU 1302 may be required to trigger connection establishment (e.g., a registration request), for example, provided the guest WTRU 1302 has been configured with hashed 3GPP ID. The PRAS 1304 may check if the guest WTRU 1302 provided hashed 3GPP ID is present in the list of allowed 3GPP IDs. To accomplish this check, the PRAS 1302 may receive (e.g., from the NEF 1308) a list of configured allowed identifiers including all the hashed 3GPP IDs from the NEF 1308. Obtaining the list of configured allowed identifiers may be done by the PRAS 1304 at request from the first guest WTRU 1302 or during the configuration time when the WTRU is being configured with the list of allowed identifiers. Next, the PRAS 1304 may share the list of configured allowed identifiers with the NEF 1308 during the configuration time. At 1312 (e.g., based on reception of the hashed guest WTRU 3GPP ID), PRAS 1304 may send it to NEF 1308, where the NEF 1308 may compare the hashed guest WTRU 3GPP ID with the allowed 3GPP IDs. The NEF 1308 may pass the information (e.g., whether the provided guest WTRU's 3GPP ID is included in the allowed list) back to the PRAS 1304 as seen at 1314. At 1316, the PRAS 1304 may send the list of allowed hashed 3GPP IDs to the guest WTRU 1302 by cell broadcast. At 1318, the PRAS 1304 may then accept or reject the registration request from the guest WTRU 1304 based on the results from the previous step, and following normal registration flow.

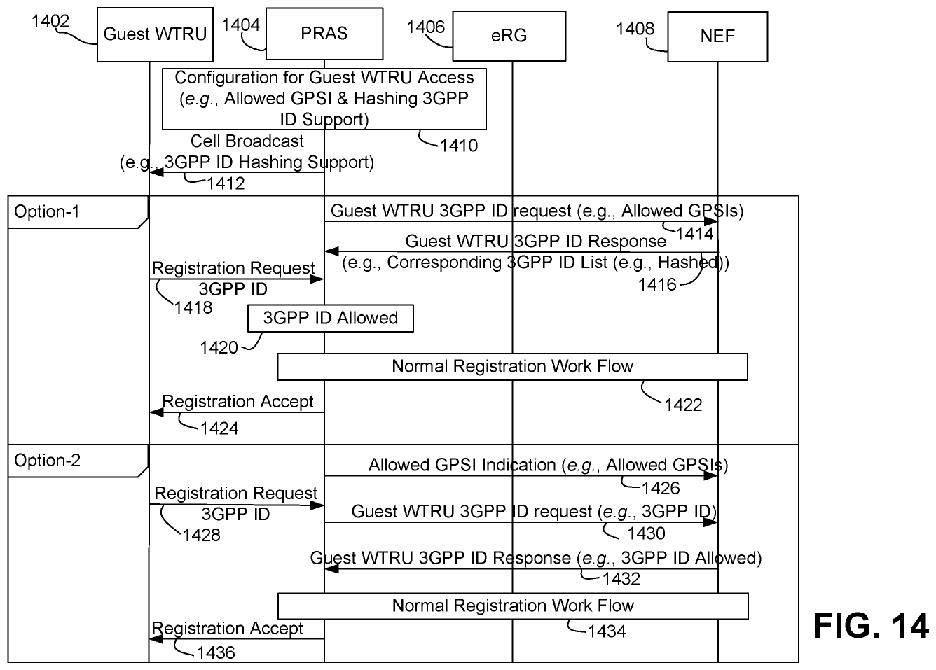

FIG. 14 illustrates an CPN access discovery. At 1410, the base station (e.g. the PRAS 1404) may be configured with a list of allowed identifiers (e.g., GPSIs) along with support for a hashed 3GPP ID feature. At 1412, the PRAS 1404 may broadcast support for 3GPP ID hashing for guest WTRU 1402 access.

For example, as depicted in Option-1 in FIG. 14, at 1414 the PRAS 1404 may send guest WTRU 1402 the 3GPP ID request to NEF 1408 (e.g., with list of configured allowed identifiers, such as GPSIs). At 1416, the NEF 1408 may respond with guest WTRU 1402 3GPP ID response (e.g. a list of corresponding, hashed 3GPP ID's). The PRAS 1404 may store the identifiers and list of hashed 3GPP IDs locally for access validation of guest WTRUs 1302. At 1418, the guest WTRU 1402 may send a registration request to the PRAS 1404 along with hashed 3GPP ID. At 1420, the PRAS 1404 may check if the provided guest WTRU's 1402 3GPP ID response (e.g., list of allowed hashed 3GPP IDs). The PRAS 1404 may confirm that the guest WTRU's 1402 3GPP ID is allowed, and then the PRAS may continue with the normal registration work flow 1422. Next, the normal registration flow 1422 involving network elements (e.g. the network node, such as the AMF) may occur. At 1424, the PRAS 1404 may respond back to the guest WTRU 1402 with registration accept message.

For example, as depicted in Option-2 in FIG. 14, at 1426, the PRAS 1404 may provide a list of allowed identifiers, such as GPSI (e.g., via allowed GPSI indication message) to the NEF 1408. The PRAS 1404 provides this list to the NEF 1408 during the configuration time or when list of allowed identifiers is updated at PRAS 1404. The NEF 1408 may retrieve the 3GPP IDs corresponding to the received GPSIs and store them locally. At 1428, the guest WTRU 1402 may send a registration request to PRAS 1404 along with hashed 3GPP ID. At 1430, the PRAS 1404 may send a guest WTRU 1402 3GPP ID request (e.g., with provided hashed 3GPP ID) to NEF 1408. At 1432, the NEF 1408 may respond back with a guest WTRU 1402 3GPP ID response (e.g., list of allowed hashed 3GPP IDs), guest WTRU 1402 is allowed to access the CPN. Next at 1434, the normal registration flow involving network elements (e.g. the network node, such as the AMF) may occur. At 1436, the PRAS 1404 may respond back to the guest WTRU 1402 with registration accept message.

In some examples, the PRAS 1404 may be configured with allowed identifiers such as GPSIs. The PRAS 1404 may send the WTRU 1402's 3GPP ID request which includes allowed identifiers, including GPSIs. The PRAS 1404 may receive a hashed WTRU 1402's 3GPP ID which corresponds to the allowed identifiers, including GPSIs. The PRAS 1404 may broadcast support for hashed 3GPP ID feature.

The guest WTRU 1402 may monitor cell broadcast for support of hashed 3GPP ID feature (e.g., if it supports this feature as well). The guest WTRU 1402 may attempt to access the PRAS 1404 by providing it's hashed 3GPP ID (e.g., if the cell broadcast message indicates support for hashed 3GPP ID feature and the guest WTRU 1402 supports this feature).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed is:

1-20. (canceled)

21. A base station device comprising:
a processor and memory, the processor and memory configured to:
receive a registration request from a wireless transmit/receive unit (WTRU), the registration request comprising an indication that the WTRU is requesting access to a private network;
send the registration request to a network node, wherein an indication of an identifier of the private network and an indication of an authorization request for the WTRU is sent with the registration request to the network node;
receive an identifier of the WTRU from the network node;
determine whether the WTRU is authorized to access the private network based on the received identifier of the WTRU and a list of allowed device identifiers for the private network;
send authorization information and an indication that the WTRU has been authorized to access the private network to the network node; and
forward a registration accept message to the WTRU.

22. The base station device of claim 21, wherein the private network is a customer premise network (CPN).

23. The base station device of claim 21, wherein the identifier is a generic public subscription identifier (GPSI).

24. The base station device of claim 21, wherein the authorization information comprises authorization information for the WTRU, the authorization information indicating one or more of an allowed CPN data name network (DNN) list, an allowed premises radio access station (PRAS) list, or an authorization expiry time.

25. The base station device of claim 21, wherein the processor and memory are configured to receive the information associated with the private network, the information comprising the list of allowed device identifiers.

26. The base station device of claim 21, wherein the base station device comprises a premises radio access station (PRAS).

27. The base station device of claim 21, wherein the network node comprises an access and mobility management function (AMF).

28. The base station device of claim 21, wherein the private network is not a public land mobile network (PLMN).

29. The base station device of claim 21, wherein the processor and memory are configured to:
receive an indication of a device type of the WTRU from the network node; and
determine whether the WTRU is authorized to access the private network based on the device type of the WTRU.

30. The base station device of claim 21, wherein the processor and memory are configured to:
receive an authorization credential from the network node before receiving the registration request from the WTRU.

31. A method performed by a base station device, the method comprising:
receiving a registration request from a wireless transmit/receive unit (WTRU), the registration request comprising an indication that the WTRU is requesting access to a private network;
sending the registration request to a network node, wherein an indication of an identifier of the private network and an indication of an authorization request for the WTRU is sent with the registration request to the network node;
receiving an identifier of the WTRU from the network node;
determining whether the WTRU is authorized to access the private network based on the received identifier of the WTRU and a list of allowed device identifiers for the private network;
sending authorization information and an indication that the WTRU has been authorized to access the private network to the network node; and
forwarding a registration accept message to the WTRU.

32. The method of claim 31, wherein the private network is a customer premise network (CPN).

33. The method of claim 31, wherein the identifier is a generic public subscription identifier (GPSI).

34. The method of claim 31, wherein the authorization information comprises authorization information for the WTRU, the authorization information indicating one or more of an allowed CPN data name network (DNN) list, an allowed premises radio access station (PRAS) list, or an authorization expiry time.

35. The method of claim 31, further comprising:
receiving the information associated with the private network, the information comprising the list of allowed device identifiers.

36. The method of claim 31, wherein the base station device comprises a premises radio access station (PRAS).

37. The method of claim 31, wherein the network node comprises an access and mobility management function (AMF).

38. The method of claim 31, wherein the private network is not a public land mobile network (PLMN).

39. The method of claim 31, further comprising:
receiving an indication of a device type of the WTRU from the network node; and
determining whether the WTRU is authorized to access the private network based on the device type of the WTRU.

40. The method of claim 31, further comprising:
receiving an authorization credential from the network node before receiving the registration request from the WTRU.
